(19) United States
(12) Patent Application Publication
(10) Pub. No.: US 2016/0266825 A1
(43) Pub. Date: Sep. 15, 2016

(54) MEMORY SYSTEM AND MEMORY CONTROLLER

(71) Applicant: KABUSHIKI KAISHA TOSHIBA, Minato-ku (JP)

(72) Inventors: Ryuta WASEDA, Yokohama (JP); Takeshi NAKANO, Kawasaki (JP); Yasuaki NAKAZATO, Kamakura (JP); Michio NAGAFUJI, Yokosuka (JP); Shigeo KURAKATA, Fujisawa (JP); Hideaki YAMAMOTO, Yokosuka (JP)

(73) Assignee: KABUSHIKI KAISHA TOSHIBA, Minato-ku (JP)

(21) Appl. No.: 14/836,164

(22) Filed: Aug. 26, 2015

Related U.S. Application Data
(60) Provisional application No. 62/130,790, filed on Mar. 10, 2015.

(51) Int. Cl. G06F 3/06; G06F 11/07

(52) U.S. Cl. CPC G06F 3/0619; G06F 3/0659; G06F 3/0679; G06F 11/073; G06F 11/0751; G06F 11/079

(57) ABSTRACT

According to one embodiment, a memory system includes a nonvolatile memory including a first storage area; and a memory controller which receives first data from a host device to access the nonvolatile memory, and causes the first storage area to store therein log data based on the first data.

### CROSS REFERENCE TO RELATED APPLICATIONS

This application is based upon and claims the benefit of priority from U.S. Provisional Application No. 62/130,790, filed Mar. 10, 2015, the entire contents of all of which are incorporated herein by reference.

### FIELD

An embodiment relates to a memory system and memory controller.

### BACKGROUND

An embedded multimedia card (eMMC) is proposed as a data storage device, and promotion of the efficiency of a method of analyzing a fault thereof is desired.

### BRIEF DESCRIPTION OF THE DRAWINGS

FIG. 1 is a block diagram showing a memory system according to an embodiment;

FIG. 2 is a block diagram showing a NAND flash memory of the memory system according to the embodiment;

FIG. 3 is a circuit diagram showing part of a cell array of the memory system according to the embodiment;

FIG. 4 is a block diagram showing a cell array in the memory system according to the embodiment;

FIG. 5 is a view showing an example of each of a RAM, access log area, and file system table in the memory system according to the embodiment;

FIG. 6 is a flowchart showing an access operation of the memory system according to the embodiment;

FIG. 7A is a waveform chart showing a consumption current in the access operation of a memory system according to a comparative example;

FIG. 7B is a waveform chart showing a consumption current in the access operation of the memory system according to the embodiment;

FIG. 8 is a flowchart showing a fault analysis operation of the memory system according to the embodiment; and

FIG. 9 is a flowchart showing a fault analysis operation of the memory system according to the comparative example.

### DETAILED DESCRIPTION

In general, according to one embodiment, a memory system includes a nonvolatile memory including a first storage area; and a memory controller which receives first data from a host device to access the nonvolatile memory, and causes the first storage area to store therein log data based on the first data.

An embodiment will be described below with reference to the drawings. In the drawings, identical parts are denoted by identical reference symbols.

### Embodiment

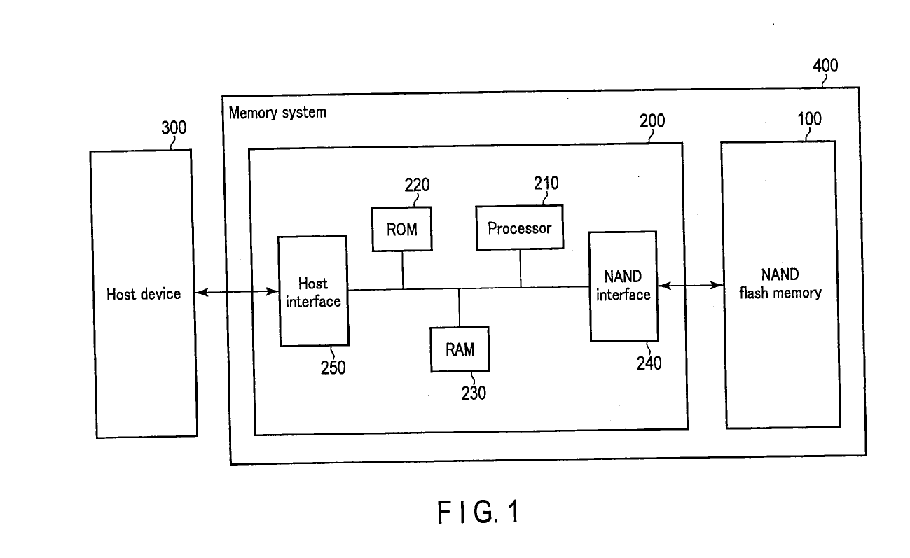

Hereinafter, a memory system according to the embodiment will be described below by using FIGS. 1 to 9.

### [Configuration in the Embodiment]

The configuration of the memory system according to the embodiment will be described below by using FIGS. 1 to 5.

In FIG. 1, a memory system will be described by taking an eMMC as an example. However, the memory system is not limited to the example, and may be a static solid device (SSD), universal flash storage (UFS) or the like.

As shown in FIG. 1, a memory system 400 according to the embodiment is provided with a NAND flash memory 100, and memory controller 200. Here, the memory system 400 will be described below by taking a NAND flash memory as an example of the storage device of the memory system 400. However, the example is not limited to this, and may also be one of other nonvolatile memories.

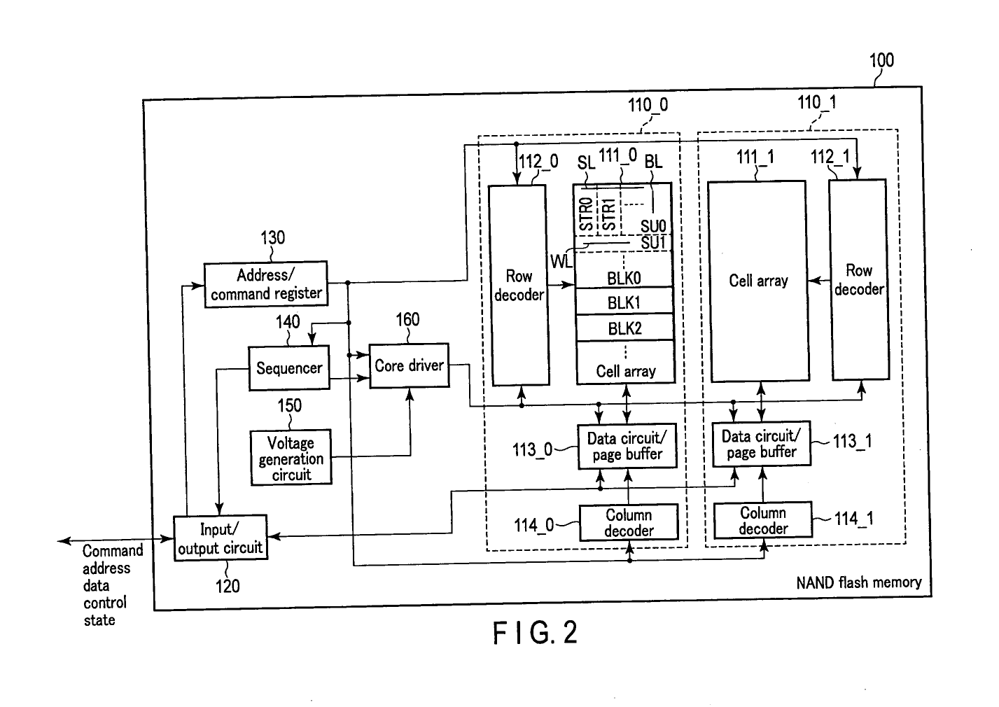

As shown in FIG. 2, the NAND flash memory 100 includes planes 110 (110_0, and 110_1), an input/output circuit 120, address/command register 130, sequencer (controller) 140, voltage generation circuit 150, and core driver 160. In FIG. 2, an example in which the two planes 110_0, and 110_1 are included is shown. The planes 110 include identical elements. Each plane 110 includes a cell array 111 (111_0 and 111_1), row decoder 112 (112_0 and 112_1), data circuit/page buffer 113 (113_0 and 113_1), and column decoder 114 (114_0 and 114_1).

The cell array 111 includes blocks BLK. Each block BLK includes string units (groups) SU (SU0, SU1, . . . ). Each string unit SU includes (NAND) strings STR. Each string STR includes memory cells. In the cell array 111, word lines WL, bit lines BL, source lines SL, and selection gate lines are provided.

The input/output circuit 120 is connected to a NAND interface 240 of the memory controller 200 through a controller bus. The input/output circuit 120 controls input of signals of a command, address, and data, and a control signal from the memory controller 200 (NAND interface 240) or output of those signals to the memory controller 200. The signals are transferred on the controller bus. The address signal specifies, for example, an address in the cell array 111, and includes a column address, and row address. The column address, and the row address respectively specify a row, and column of the cell array 111. The row address includes a plane address, block address, string (string unit) address, and page address. The plane address, the block address, the string address, and the page address respectively specify a plane 110, block BLK, string STR (string unit SU), and word line WL.

The address/command register 130 receives a command/address signal through the input/output circuit 120, and retains the received signal. The sequencer 140 receives a command from the address/command register 130, and controls the voltage generation circuit 150, and the core driver 160 according to a sequence based on the command. The voltage generation circuit 150 generates various voltages (potentials) in accordance with an instruction from the sequencer 140.

The core driver 160 operates in accordance with an instruction from the sequencer 140, and receives the various voltages from the voltage generation circuit 150. The core driver 160 controls the data circuit/page buffer 113 in order to control the bit lines BL. The core driver 160 generates a voltage to be applied to the word line WL, and selected gate line by using a voltage from the voltage generation circuit 150. More specifically, the core driver 160 generates a voltage to be applied to a word line WL or other word lines WL specified by the page address. Besides, the core driver 160 generates a voltage to be applied to a selected gate line of the string unit SU specified by the string address.

The row decoder 112 receives an address signal from the address/command register 130, and receives a voltage to be applied to the word line WL and the selected gate line from the core driver 160. The row decoder 112 of a plane 110 specified by the address signal transfers the voltage from the core driver 160 to a block BLK specified by a block address signal.

The data circuit/page buffer 113 temporarily retains data read from the cell array 111, receives write data from the outside of the NAND flash memory 100, and writes the received data to a selected memory cell. The column decoder 114 receives a column address signal from the address/command register 130. The column decoder 114 controls input/output of data of the data circuit/page buffer 113 on the basis of the column address signal.

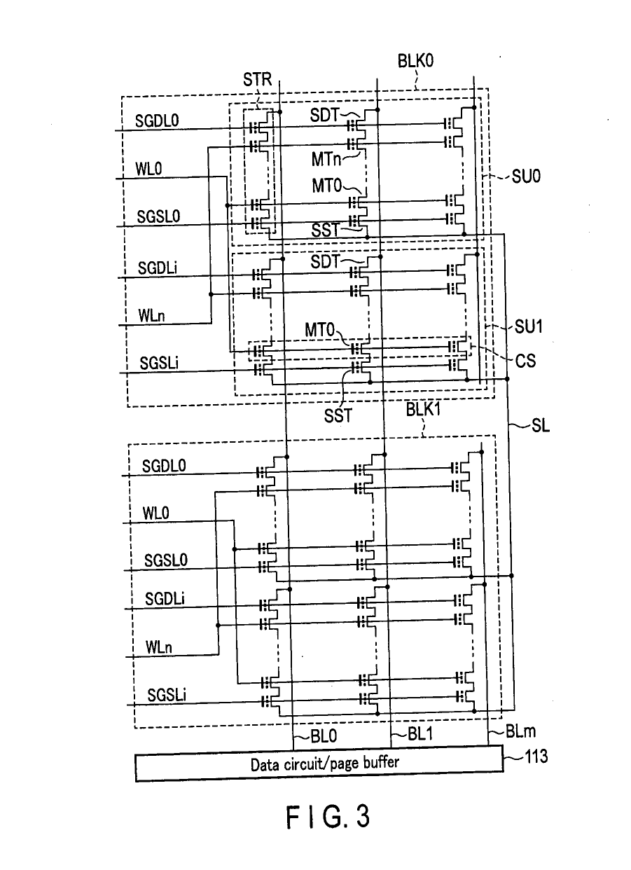

As shown in FIG. 3, each block BLK in the cell array 111 has the same configuration, and includes i+1 (i is a natural number) string units SU (SU0 to Sui). Each string unit SU includes strings STR. Besides, the cell array 111 includes m+1 (m is a natural number) bit lines BL (BL0 to BLm), and a source line SL. In each block BLK, i+1 strings STR are connected to one bit line BL.

One string STR includes n+1 series-connected cell transistors MT0 to MTn, a source-side selection gate transistor SST, and drain-side selection gate transistor SDT. Here, n is a natural number, for example, 47, and the following description is based on an example in which n is 47 (n=47). The cell transistor MT functions as a memory cell. In each string STR, a drain of a transistor SST is connected to a source of a cell transistor MT0. A source of a transistor SDT is connected to a drain of a cell transistor MT47. A source of the transistor SST is connected to the source line SL. A drain of the transistor SDT is connected to a corresponding bit line BL.

Strings STR arranged along the word line WL constitute a string unit SU. For example, all the strings STR arranged along the word line WL, and respectively connected to all the bit lines BL constitute one string unit SU. In each string unit SU, a gate of each of cell transistors MTy (y is 0 or a natural number) of each of the strings STR is connected to the word line WLy as common connection.

In each string unit SU, a gate of each of transistors SDT of each of the strings STR is connected to the drain-side selection gate line SGDL as common connection. Selection gate lines SGDL0 to SGDLi are respectively provided for the string units SU0 to SUi.

In each string unit SU, a gate of each of transistors SST of each of the strings STR is connected to the source-side selection gate line SGSL as common connection. Source-side selection gate lines SGSL0 to SGSLi are respectively provided for the string units SU0 to SUi.

Cell transistors MT connected to one word line WL in one string unit SU constitute a cell set CS. Write and read are collectively carried out in each cell set CS. This data unit is called a “page”. In the NAND flash memory 100, data more than or equal to two bits can be retained in one memory cell. When a memory cell retains data of two bits, one cell set CS stores therein data of two pages. In this case, page addresses are assigned to one cell set CS. It is also possible for one memory cell to retain data more than or equal to three bits. The following description is based on an example in which data of two bits is stored in one memory cell. A word line WL to be selected is identified by an address of a page to which access is instructed to be gained.

In each block BLK, word lines WLy of the same number (address) in different strings STR are connected to each other.

In order to access a cell transistor MT, one block BLK is selected, and one string unit SU is selected. For selection of the block BLK, a signal used to select a block BLK is supplied only to a block BLK specified by the block address signal. In the selection block BLK, a word line WL, and selection gate lines SGSL, and SGDL are connected to a driver in the core driver 160 by this block selection signal.

Furthermore, for selection of one string unit SU, the selection gate transistors SST, and SDT receive a voltage for selection only in the selection string unit SU. In the non-selection string unit SU, the selection gate transistors SST, and SDT receive a voltage for non-selection. The voltage for selection depends on operations of read, write, and the like. Likewise, the voltage for non-selection depends on operations of read, write, and the like.

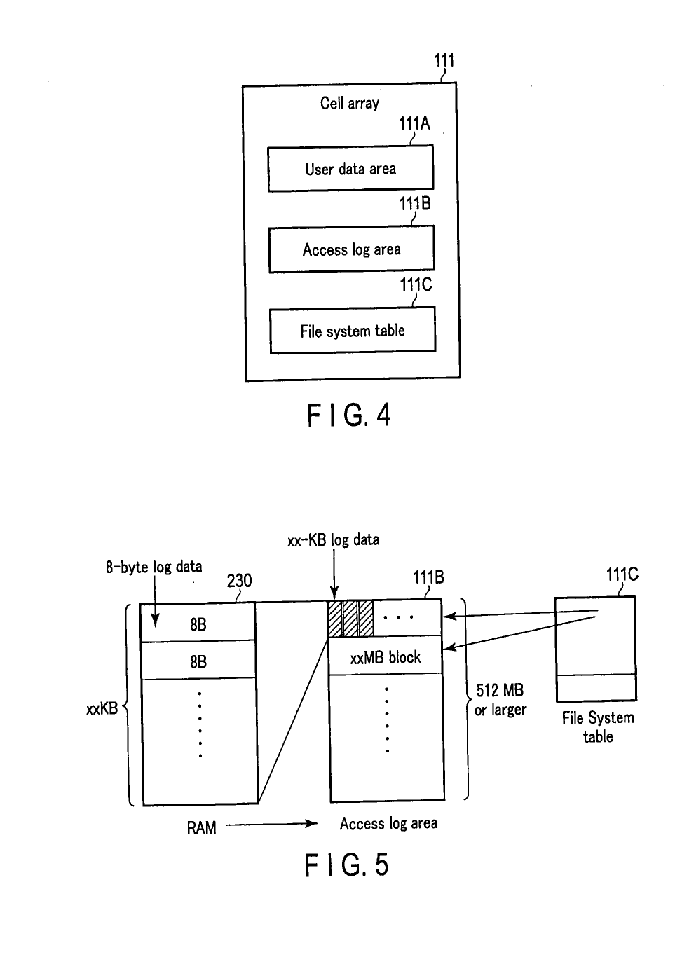

As shown in FIG. 4, the cell array 111 includes a user data area 111A, access log area 111B, and file system table 111C.

The user data area 111A stores therein user data input from the memory controller 200 (NAND interface 240).

The access log area 111B stores therein log data from the memory controller 200 (NAND interface 240). The access log area 111B has, for example, the storage capacity greater than or equal to 512 MB. In order to carry out read of the access log area 111B, a dedicated read command from outside (for example, the host) is required, and the user is inhibited from carrying out read of the access log area 111B.

The file system table 111C stores therein address information about the access log area 111B in accordance with the control of the memory controller 200.

As shown in FIG. 1, the memory controller 200 controls the NAND flash memory 100. The memory controller 200 includes a processor 210 such as a central processing unit (CPU) or the like, read only memory (ROM) 220, random access memory (RAM) 230, NAND interface 240, and host interface 250.

For example, a program retained in the ROM 220 is executed by the processor 210, whereby the memory controller 200 carries out various operations. The RAM 230 retains temporary data, and also functions as a work area of the processor 210.

More specifically, the processor 210 carries out an operation (write, read, erase operation, and the like) of access to the NAND flash memory 100 on the basis of host data from the host device 300. The host data (first data) includes a command, address, and user data transferred from the host device 300. At this time, the processor 210 carries out an operation of access to the user data area 111A.

Besides, the processor 210 packetizes, together with the access operation described above, second data based on the host data to create log data. The second data includes a command, address, data size (size of the user data), and the like, and is data necessary to reproduce host data input afterward. It should be noted that the second data is not limited to a command, address, and data size, and may include user data, and a time stamp. The log data is data obtained by packetizing the second data to, for example, about 8 bytes, and indicates a log of access from the host device 300. The RAM 230 retains created log data in sequence. When a predetermined amount (first amount) of log data has accumulated in the RAM 230, the processor 210 issues a dedicated command to the NAND flash memory 100. The processor 210 further causes an access log area 111B in the NAND flash memory 100 to store therein the log data. When the amount of the log data of the access log area 111B exceeds the storage capacity thereof, the processor 210 deletes the data in the access log area 111B in sequence from the older log data. Further, the processor 210 stores new log data in the emptied part of the access log area 111B.

Furthermore, the processor 210 stores address information about the access log area 111B including the log data in a file system table 223.

The NAND interface 240 is connected to the NAND flash memory 100 through a bus, for example, a NAND bus or the like, and administers the communication between the memory controller 200 and NAND flash memory 100. Part of the functions of the NAND interface 240 can be realized by a program to be executed by the processor 210. The host interface 250 is connected to the host device 300 through a bus, for example, a controller bus or the like, and administers the communication between the memory controller 200 and host device 300. Part of the functions of the host interface 250 can be realized by a program to be executed by the processor 210.

As shown in FIG. 5, the RAM 230 in the memory controller 200 stores therein the created 8-byte log data in sequence. When the first amount (for example, xx KB) of log data has accumulated in the RAM 230, the log data is transferred to the access log area 111B in the NAND flash memory 100. The first amount is, for example, an amount corresponding to the storage capacity of the RAM 230. When the first amount of log data is transferred to the access log area 111B in sequence in this manner, the access log area 111B stores therein a second amount (for example, xx MB) of log data as one block. The access log area 111B includes blocks each storing therein log data, and their capacity reaches the capacity, for example, greater than or equal to 512 MB. The file system table 111C manages the log data in units of blocks, and stores therein these address information.

### [Access Operation in the Embodiment]

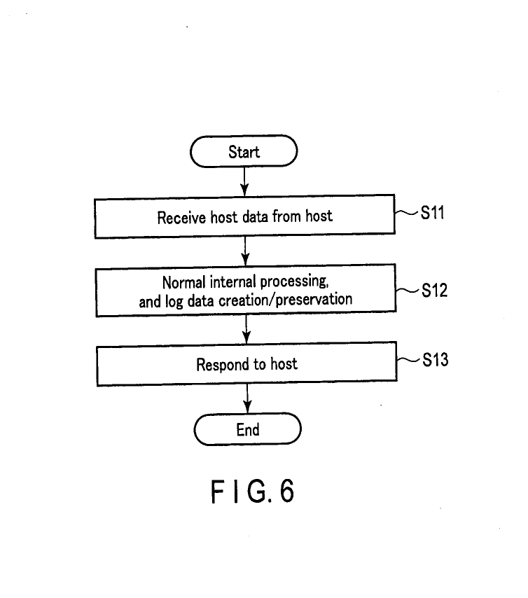

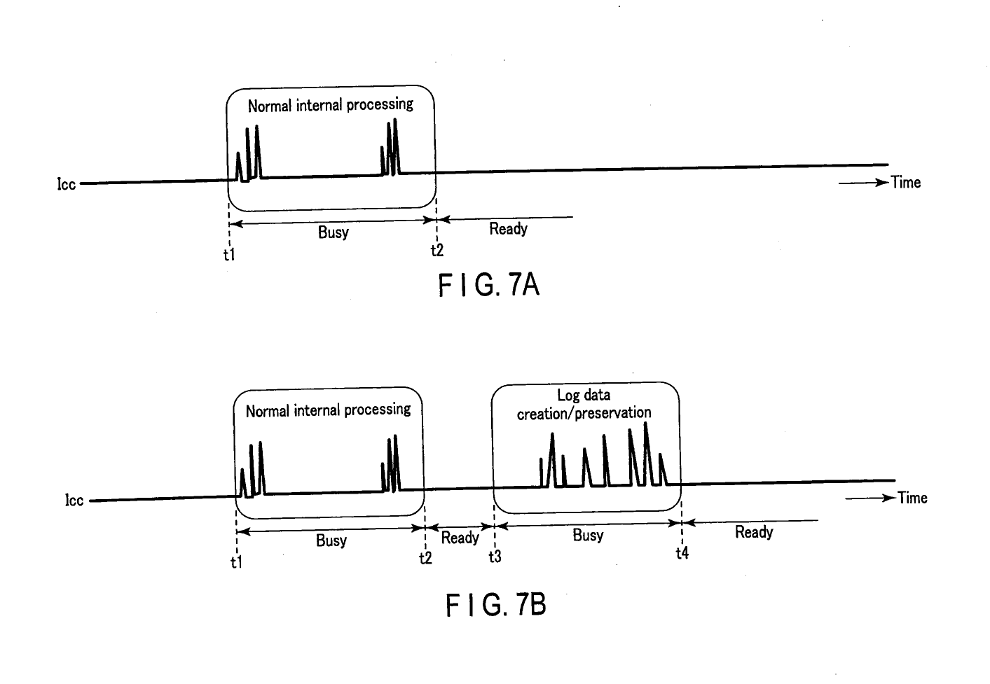

An access operation of the memory system according to the embodiment will be described below by using FIG. 6, and FIG. 7.

As shown in FIG. 6, first in step S11, the memory controller 200 receives host data (a command, address, user data, and the like) from the host device 300.

Next, in step S12, on the basis of the host data, the memory controller 200 carries out normal internal processing, i.e., an operation (write, read, erase operation, and the like) of access to the NAND flash memory 100. At this time, the memory controller 200 carries out the access operation to the user data area 111A.

Besides, the memory controller 200 packetizes, together with the access operation described above, second data based on the host data to create log data. The memory controller 200 issues a dedicated command to cause the access log area 111B in the NAND flash memory 100 to store therein the log data.

Thereafter, in step S13, the memory controller 200 responds to the host device 300 about a result of the access operation.

In this manner, the access operation of the memory system according to the embodiment terminates.

As shown in FIG. 7A and FIG. 7B, upon receipt of host data from the host device 300, the memory system 400 carries out normal internal processing (access operation) in the period from the time t1 to the time t2. At this time, the same access operation as a comparative example is carried out in the embodiment, and hence the same current is consumed. That is, a current used to carry out the access operation is consumed. Thereafter, in the embodiment, the memory system 400 carries out log data creation/preservation processing in the period from the time t3 to the time t4. Accordingly, in the embodiment, a current different from the comparative example is consumed in the period from the time t3 to the time t4. That is, a current used to carry out log data creation/preservation processing is consumed.

In the comparative example, and in the embodiment, a state where access to the NAND flash memory 100 is inhibited (a state where data reception is inhibited) is held, i.e., the busy state is held in the period from the time t1 to the time t2. Thereafter, in the comparative example, a state where access to the NAND flash memory 100 is enabled, i.e., a ready state is held at and after the time t2. On the other hand, in the embodiment, a ready state is held in the period from the time t2 to the time t3, and thereafter a busy state is held again in the period from the time t3 to the time t4. Then, at and after the time t2, a ready state is held.

It should be noted that in FIG. 7A, although an example in which the log data creation/preservation processing is carried out after the access operation is shown, the example is not limited to this, and the log data creation/preservation processing may also be carried out simultaneously with the access operation or before the access operation.

### [Fault Analysis Operation in the Embodiment]

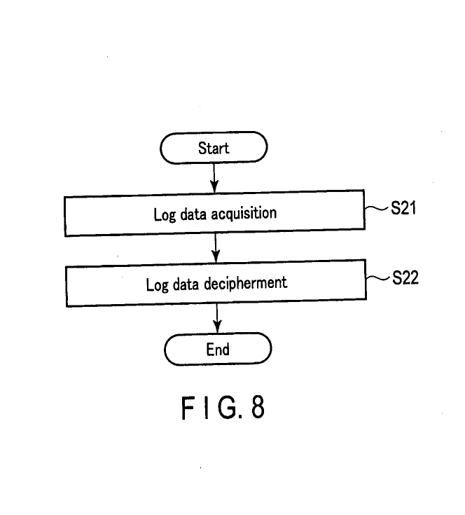

A fault analysis operation of the memory system according to the embodiment will be described below by using FIG. 8.

As shown in FIG. 8, in the embodiment, first in step S21, the memory system 400 is connected to a computer (host), and log data is acquired by the computer. At this time, the computer issues a dedicated read command to the memory system 400. Thereby, the log data stored in the access log area 111B in the NAND flash memory 100 is read into the computer.

Next, in step S22, the log data is deciphered by the computer. Then, the fault is analyzed on the basis of the deciphered log data.

In this manner, the fault analysis operation of the memory system according to the embodiment is carried out.

### [Advantage According to the Embodiment]

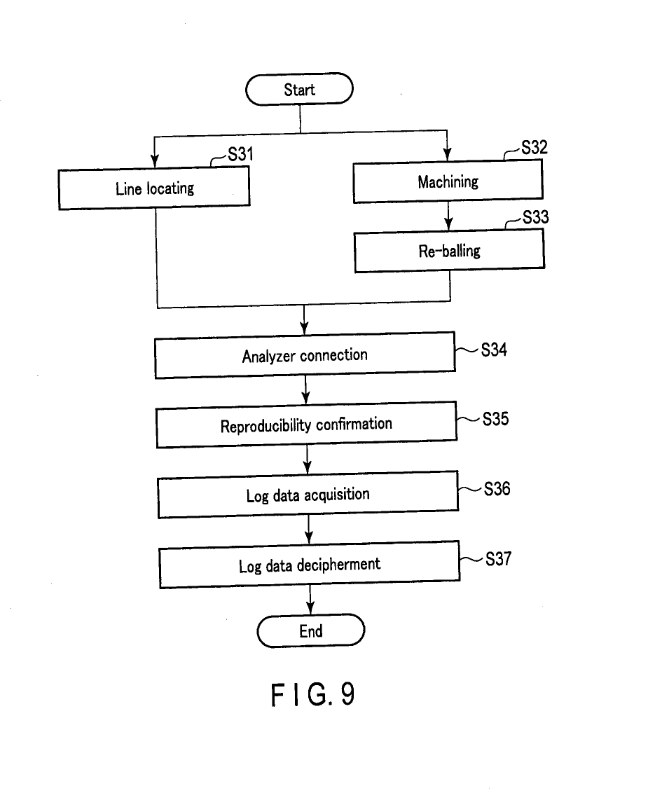

As shown in FIG. 9, in the comparative example, first in step S31, line locating is carried out. That is, a lead wire is connected to the input/output port of the memory system.

Thereafter, in step S34, an analyzer is connected to the lead wire.

On the other hand, when there is no input/output port of the memory system, machining is carried out in step S32. That is, a substrate on which the memory system is mounted is physically machined, and the memory system is thereby dismounted from the substrate. Next, re-balling is carried out in step S33, whereby solder balls removed by the machining are attached to the memory system again.

Thereafter, in step S34, the analyzer is connected to the dismounted memory system.

Next, in step S35, an interview with the user is carried out by using the analyzer to confirm the reproducibility of the fault occurrence and, in step S36, log data is acquired. Thereafter, analysis of the log data is carried out in step S37 by using a computer or the like. Then, the fault is analyzed on the basis of the deciphered log data.

As described above, by the fault analysis operation of the memory system in the comparative example, it takes a long time (about seven days) to acquire the log data. When the reproducibility of the fault is poor, log data must be acquired even many times until it becomes possible to reproduce the fault, thereby further requiring a longer time.

Conversely, by the embodiment described above, the NAND flash memory 100 is provided with an access log area 111B. The memory controller 200 creates log data on the basis of access (host data) from the host device 300, and stores the log data in the access log area 111B. Thereby, it is possible to acquire log data only by reading the stored log data without confirming the reproducibility of the fault occurrence after data has been returned on account of fault or the like. Accordingly, it is possible to carry out fault analysis easily and in a shortening manner. According to the embodiment, it is possible to carry out a fault analysis operation within a short time of, for example, about two days.

It should be noted that in the embodiment, log data of a sudden/unexpected operation (for example, sudden power shutdown or the like) is not stored in the NAND flash memory 100 in some cases. In such a case, log data cannot be obtained by reading the log data in the fault analysis operation, and hence the same operation as the comparative example is carried out.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory including a first storage area; and
a memory controller which receives first data from a host device to access the nonvolatile memory, and stores log data based on the first data in the first storage area.

2. The system of claim 1, wherein
the log data is data obtained by packetizing second data based on the first data.

3. The system of claim 2, wherein
the second data includes a command, an address, and a data size of user data.

4. The system of claim 3, wherein
the second data further includes a time stamp.

5. The system of claim 1, wherein
the nonvolatile memory further includes a second storage area storing therein address information about the first storage area.

6. The system of claim 1, wherein
the memory controller internally retains a predetermined amount of the log data and, thereafter causes the first storage area to store therein the predetermined amount of the log data.

7. The system of claim 1, wherein
when causing the first storage area to store therein the log data, the memory controller issues a dedicated command.

8. The system of claim 1, wherein
the log data stored in the first storage area is acquired and deciphered, whereby fault analysis is carried out.

9. The system of claim 8, wherein
when the log data is to be acquired, a dedicated read command is transferred from outside to the memory controller.

10. A memory controller receiving first data from a host device to access a nonvolatile memory, and storing log data based on the first data in a first storage area of the nonvolatile memory.

11. The controller of claim 10, wherein
the log data is data obtained by packetizing second data based on the first data.

12. The controller of claim 11, wherein
the second data includes a command, an address, and a data size of user data.

13. The controller of claim 12, wherein
the second data further includes a time stamp.

14. The controller of claim 10, wherein
the nonvolatile memory further includes a second storage area storing therein address information about the first storage area.

15. The controller of claim 10, internally retaining a predetermined amount of the log data and, thereafter causes the first storage area to store therein the predetermined amount of the log data.

16. The controller of claim 10, issuing a dedicated command when causing the first storage area to store therein the log data.
